(19) United States
(12) Patent Application Publication
(10) Pub. No.: US 2022/0052565 A1
(43) Pub. Date: Feb. 17, 2022

(54) Resonant Reflection Device Detection

(71) Applicant: AIRA, Inc., Chandler, AZ (US)

(72) Inventor: Eric Heindel Goodchild, Phoenix, AZ (US)

(21) Appl. No.: 17/400,068

(22) Filed: Aug. 11, 2021

Related U.S. Application Data
(60) Provisional application No. 63/066,221, filed on Aug. 15, 2020.

(51) Int. Cl. H02J 50/90; H02J 50/40; H02J 50/12; H02J 7/00

(52) U.S. Cl. CPC H02J 50/90; H02J 50/402; H02J 7/00718; H02J 7/0047; H02J 50/12

(57) ABSTRACT

Systems, methods and apparatus for wireless charging are disclosed. A charging device has a plurality of charging cells provided on a charging surface, a charging circuit and a controller. The controller may be configured to cause the charging circuit to cause an excitation flux to be transmitted from the charging device, determine that a compatible chargeable device is available for charging by the charging device when resonance is detected in response to the excitation flux, and provide a charging current to a power transmitting coil of the charging device. The excitation flux may be transmitted in a first range of frequencies that includes a first nominal resonant frequency associated with compatible chargeable devices. The charging current may be provided in a second range of frequencies that includes a second nominal resonant frequency associated with the compatible chargeable devices.

### PRIORITY CLAIM

This application claims priority to and the benefit of provisional patent application No. 63/066,221 filed in the United States Patent Office on Aug. 15, 2020, and the entire content of this application is incorporated herein by reference as if fully set forth below in their entirety and for all applicable purposes.

### TECHNICAL FIELD

The present invention relates generally to wireless charging of batteries, including batteries in mobile computing devices, and more particularly to detection of devices placed near a charging device.

### BACKGROUND

Wireless charging systems have been deployed to enable certain types of devices to charge internal batteries without the use of a physical charging connection. Devices that can take advantage of wireless charging include mobile processing and/or communication devices. Standards, such as the Qi standard defined by the Wireless Power Consortium enable devices manufactured by a first supplier to be wirelessly charged using a charger manufactured by a second supplier. Standards for wireless charging are optimized for relatively simple configurations of devices and tend to provide basic charging capabilities.

Improvements in wireless charging capabilities are required to support continually increasing complexity of mobile devices and changing form factors. For example, there is a need for a faster, lower power detection techniques that enable a charging device to detect and locate chargeable devices on a surface of a charging device.

### BRIEF DESCRIPTION OF THE DRAWINGS

FIG. 1 illustrates an example of a charging cell that may be provided on a charging surface provided by a wireless charging device in accordance with certain aspects disclosed herein.

FIG. 2 illustrates an example of an arrangement of charging cells provided on a single layer of a segment of a charging surface provided by a wireless charging device in accordance with certain aspects disclosed herein.

FIG. 3 illustrates an example of an arrangement of charging cells when multiple layers of charging cells are overlaid within a segment of a charging surface provided by a wireless charging device in accordance with certain aspects disclosed herein.

FIG. 4 illustrates the arrangement of power transfer areas provided by a charging surface of a charging device that employs multiple layers of charging cells configured in accordance with certain aspects disclosed herein.

FIG. 5 illustrates a wireless power transmitter that may be provided in a wireless charging device that may be adapted in accordance with certain aspects disclosed herein.

FIG. 6 illustrates a wireless power receiver that may be provided in a chargeable device in accordance with certain aspects disclosed herein.

FIG. 7 illustrates an example of a charging surface in a wireless charger that is configured to detect the presence of a chargeable device placed on or near the charging surface in accordance with certain aspects disclosed herein.

FIG. 8 illustrates a first example of a detection circuit configured to detect a compatible chargeable device in accordance with certain aspects of this disclosure.

FIG. 9 illustrates frequency responses that may be observed at a transmitting coil when an excitation signal is transmitted over a range of frequencies in accordance with certain aspects disclosed herein.

FIG. 10 is a response diagram that illustrates phase responses corresponding to phase difference between a reflected or retransmitted signal and the excitation signal over a range of frequencies in accordance with certain aspects disclosed herein.

FIG. 11 illustrates a second example of a detection circuit configured to detect compatible chargeable devices in accordance with certain aspects of this disclosure.

FIG. 12 is a response diagram that illustrates frequency responses that may be observed at a transmitting coil when an excitation signal is transmitted over a range of frequencies in accordance with certain aspects disclosed herein.

FIG. 13 is a response diagram that illustrates phase responses observed at a transmitting coil when an excitation signal is transmitted over a range of frequencies in accordance with certain aspects disclosed herein.

FIG. 14 illustrates a third example of a detection circuit configured to detect a compatible chargeable device in accordance with certain aspects of this disclosure.

FIG. 15 illustrates responses observed at a transmitting coil after a pulse has been transmitted in an excitation signal in accordance with certain aspects disclosed herein.

FIG. 16 illustrates a physical configuration of proximately located devices in accordance with certain aspects disclosed herein.

FIG. 17 illustrates one example of an apparatus employing a processing circuit that may be adapted according to certain aspects disclosed herein.

FIG. 18 illustrates a method for operating a charging device in accordance with certain aspects of this disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of wireless charging systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a processor-readable storage medium. A processor-readable storage medium, which may also be referred to herein as a computer-readable medium may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), Near Field Communications (NFC) token, random access memory (RAM), read only memory (ROM), programmable ROM (PROM), erasable PROM (EPROM), electrically erasable PROM (EEPROM), a register, a removable disk, a carrier wave, a transmission line, and any other suitable medium for storing or transmitting software. The computer-readable medium may be resident in the processing system, external to the processing system, or distributed across multiple entities including the processing system. Computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

### Overview

Certain aspects of the present disclosure relate to systems, apparatus and methods applicable to wireless charging devices and techniques. Charging cells may be configured with one or more inductive coils to provide a charging surface in a charging device where the charging surface enables the charging device to charge one or more chargeable devices wirelessly. The location of a device to be charged may be detected through sensing techniques that associate location of the device to changes in a physical characteristic centered at a known location on the charging surface. Sensing of location may be implemented using capacitive, resistive, inductive, touch, pressure, load, strain, and/or another appropriate type of sensing.

In one aspect of the disclosure, a for operating a charging device includes transmitting an excitation flux from the charging device, the excitation flux being transmitted in a first range of frequencies that includes a first nominal resonant frequency associated with compatible chargeable devices, determining that a compatible chargeable device is available for charging by the charging device when resonance is detected in response to the excitation flux, and providing a charging current to a power transmitting coil of the charging device, the charging current being provided in a second range of frequencies that includes a second nominal resonant frequency associated with the compatible chargeable devices.

In some instances, the charging device may provide a charging surface whereby power can be wirelessly transferred to a receiving device located anywhere on the charging surface. Receiving devices can have an arbitrarily defined size and/or shape and may be placed without regard to any discrete placement locations enabled for charging. Multiple devices can be simultaneously charged on a single charging surface. The apparatus can track motion of one or more devices across the charging surface.

### Charging Cells

According to certain aspects disclosed herein, a charging surface may be provided using charging cells in a charging device, where the charging cells are deployed adjacent to the charging surface. In one example the charging cells are deployed in one or more layers of the charging surface in accordance with a honeycomb packaging configuration. A charging cell may be implemented using one or more coils that can each induce a magnetic field along an axis that is substantially orthogonal to the charging surface adjacent to the coil. In this description, a charging cell may refer to an element having one or more coils where each coil is configured to produce an electromagnetic field that is additive with respect to the fields produced by other coils in the charging cell and directed along or proximate to a common axis. In some examples, the coils in a charging cell are formed using traces on a printed circuit board. In some examples, a coil in a charging cell is formed by spirally winding a wire to obtain a planar coil or a coil that has a generally cylindrical outline. In one example, Litz wire may be used to form a planar or substantially flat winding that provides a coil with a central power transfer area.

In some implementations, a charging cell includes coils that are stacked along a common axis and/or that overlap such that they contribute to an induced magnetic field substantially orthogonal to the charging surface. In some implementations, a charging cell includes coils that are arranged within a defined portion of the charging surface and that contribute to an induced magnetic field within the substantially orthogonal portion of the charging surface associated with the charging cell. In some implementations, charging cells may be configurable by providing an activating current to coils that are included in a dynamically defined charging cell. For example, a charging device may include multiple stacks of coils deployed across the charging surface, and the charging device may detect the location of a device to be charged and may select some combination of stacks of coils to provide a charging cell adjacent to the device to be charged. In some instances, a charging cell may include, or be characterized as a single coil. However, it should be appreciated that a charging cell may include multiple stacked coils and/or multiple adjacent coils or stacks of coils. The coils may be referred to herein as charging coils, wireless charging coils, transmitter coils, transmitting coils, power transmitting coils, power transmitter coils, or the like.

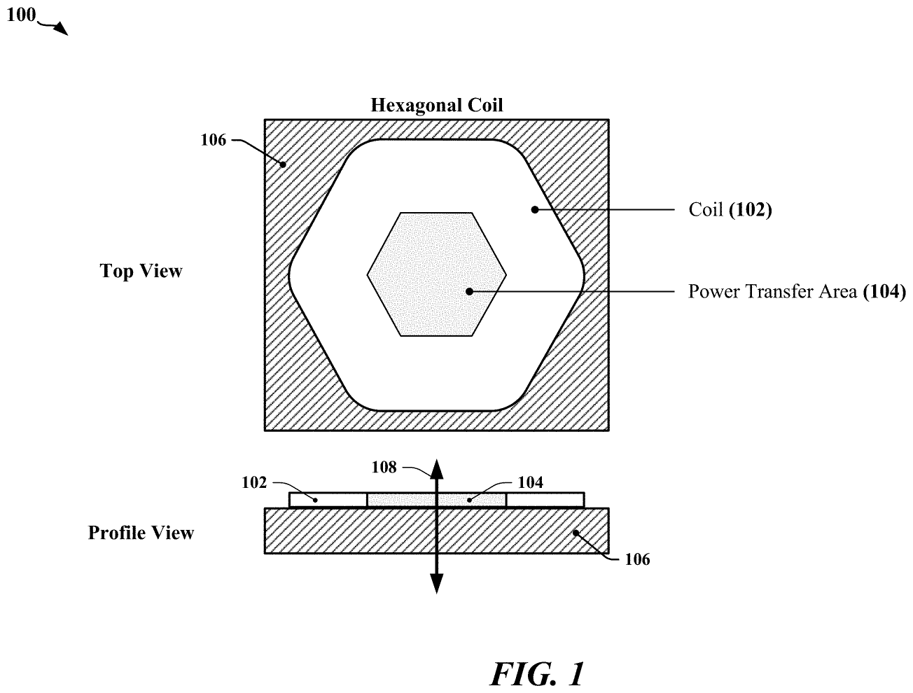

FIG. 1 illustrates an example of a charging cell 100 that may be deployed and/or configured to provide a charging surface of a charging device. As described herein, the charging surface may include an array of charging cells 100 provided on one or more substrates 106. A circuit comprising one or more integrated circuits (ICs) and/or discrete electronic components may be provided on one or more of the substrates 106. The circuit may include drivers and switches used to control currents provided to coils used to transmit power to a receiving device. The circuit may be configured as a processing circuit that includes one or more processors and/or one or more controllers that can be configured to perform certain functions disclosed herein. In some instances, some or all of the processing circuit may be provided external to the charging device. In some instances, a power supply may be coupled to the charging device.

The charging cell 100 may be provided in close proximity to an outer surface area of the charging device, upon which one or more devices can be placed for charging. The charging device may include multiple instances of the charging cell 100. In one example, the charging cell 100 has a substantially hexagonal shape that encloses one or more coils 102, which may be constructed using conductors, wires or circuit board traces that can receive a current sufficient to produce an electromagnetic field in a power transfer area 104. In various implementations, some coils 102 may have a shape that is substantially polygonal, including the hexagonal charging cell 100 illustrated in FIG. 1. Other implementations provide coils 102 that have other shapes. The shape of the coils 102 may be determined at least in part by the capabilities or limitations of fabrication technology, and/or to optimize layout of the charging cells on a substrate 106 such as a printed circuit board substrate. Each coil 102 may be implemented using wires, printed circuit board traces and/or other connectors in a spiral configuration. Each charging cell 100 may span two or more layers separated by an insulator or substrate 106 such that coils 102 in different layers are centered around a common axis 108.

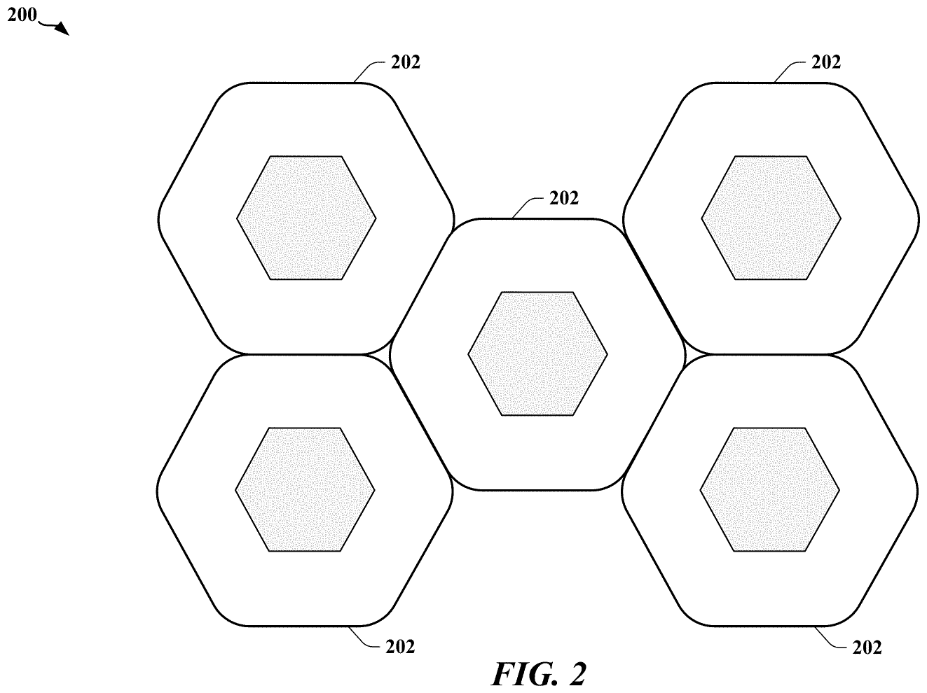

FIG. 2 illustrates an example of an arrangement 200 of charging cells 202 provided on a single layer of a segment of a charging surface of a charging device that may be adapted in accordance with certain aspects disclosed herein. The charging cells 202 are arranged according to a honeycomb packaging configuration. In this example, the charging cells 202 are arranged end-to-end without overlap. This arrangement can be provided without through-hole or wire interconnects. Other arrangements are possible, including arrangements in which some portion of the charging cells 202 overlap. For example, wires of two or more coils may be interleaved to some extent.

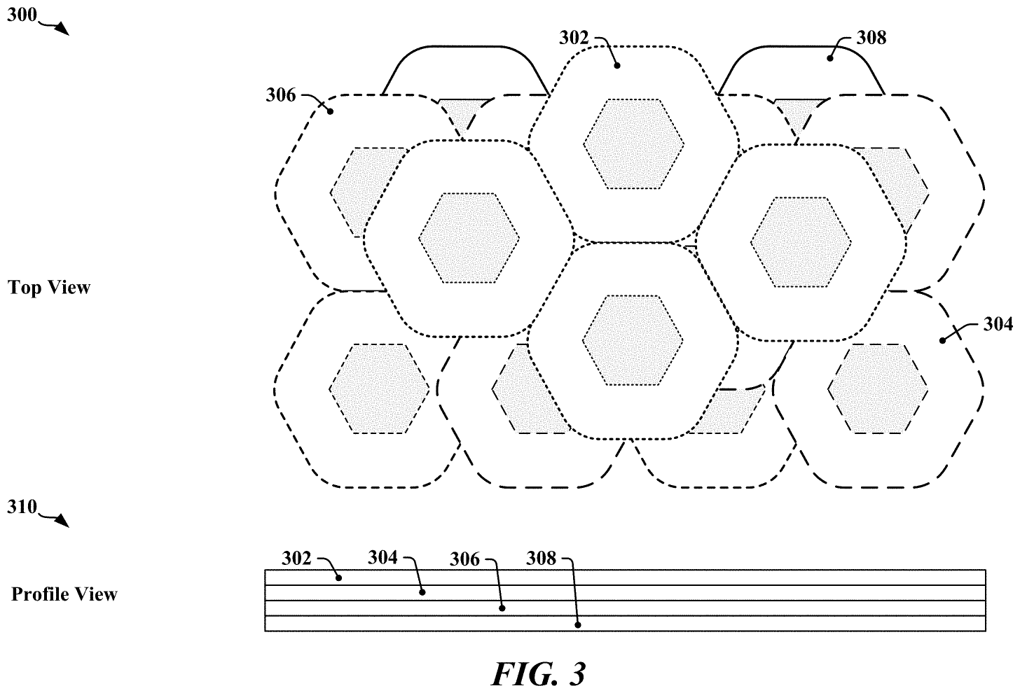

FIG. 3 illustrates an example of an arrangement of charging cells from two perspectives 300, 310 (e.g., top and profile views) when multiple layers are overlaid within a segment of a charging surface that may be adapted in accordance with certain aspects disclosed herein. Layers of charging cells 302, 304, 306, 308 are provided within a segment of a charging surface. The charging cells within each layer of charging cells 302, 304, 306, 308 are arranged according to a honeycomb packaging configuration. In one example, the layers of charging cells 302, 304, 306, 308 may be formed on a printed circuit board that has four or more layers. The arrangement of charging cells 100 can be selected to provide complete coverage of a designated charging area that is adjacent to the illustrated segment. The charging cells may be 302, 304, 306, 308 illustrated in FIG. 3 correspond to power transfer areas provided by transmitting coils that are polygonal in shape. In other implementations, the charging coils may comprise spirally wound planar coils constructed from wires, each being wound to provide a substantially circular power transfer area. In the latter examples, multiple spirally wound planar coils may be deployed in stacked planes below the charging surface of a wireless charging device.

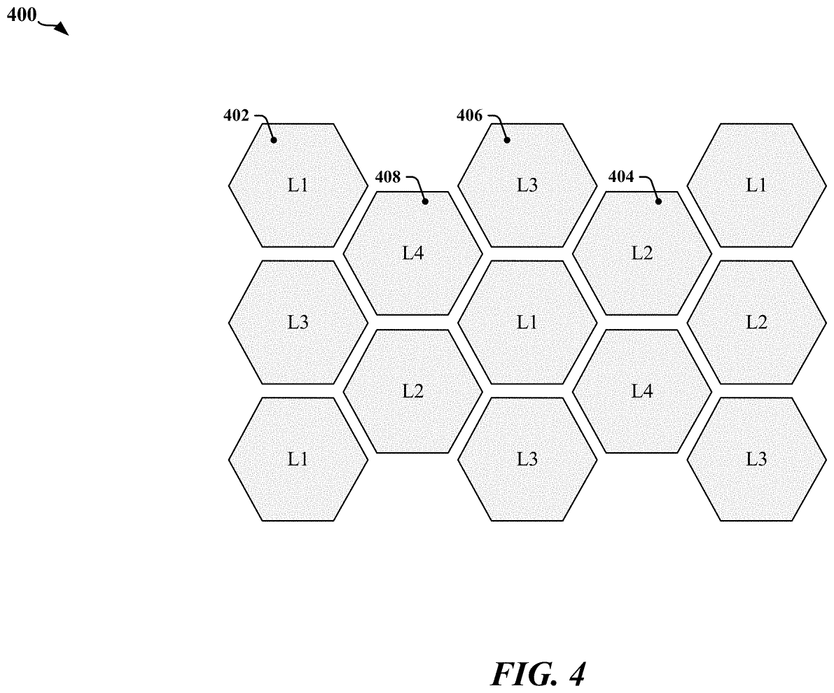

FIG. 4 illustrates the arrangement of power transfer areas provided in a charging surface 400 that employs multiple layers of charging cells configured in accordance with certain aspects disclosed herein. The illustrated charging surface is constructed from four layers of charging cells 402, 404, 406, 408, which may correspond to the layers of charging cells 302, 304, 306, 308 in FIG. 3. In FIG. 4, each power transfer area provided by a charging cell in the first layer of charging cells 402 is marked “L1”, each power transfer area provided by a charging cell in the second layer of charging cells 404 is marked “L2”, each power transfer area provided by a charging cell in the third layer of charging cells 406 is marked “L3”, and each power transfer area provided by a charging cell in the fourth layer of charging cells 408 is marked “L4”.

### Wireless Transmitter

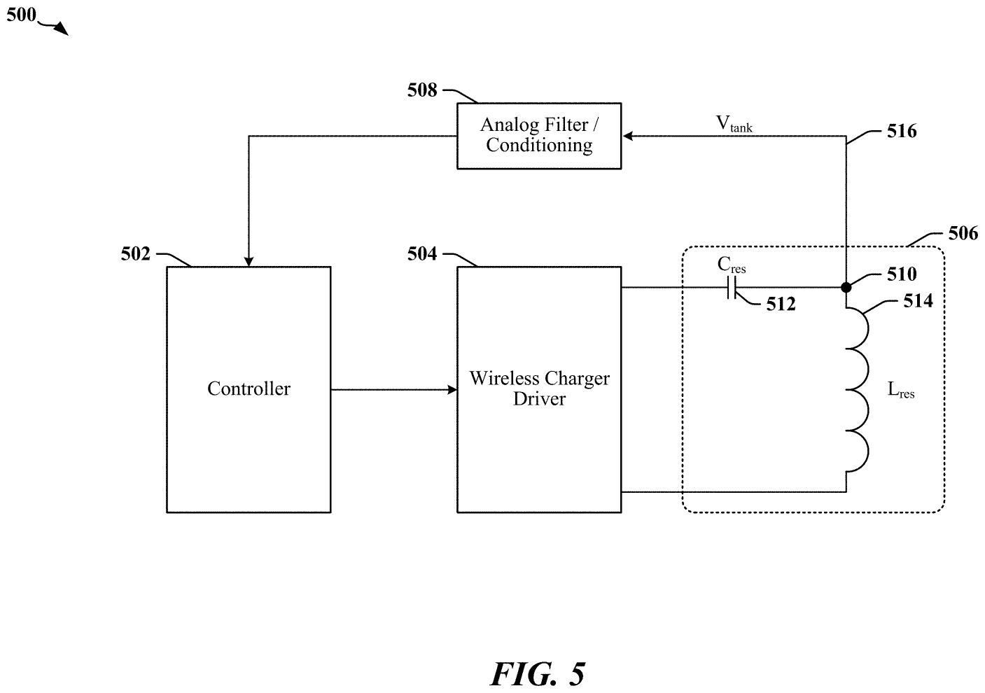

FIG. 5 illustrates an example of a wireless transmitter 500 in a wireless charging device that may be adapted in accordance with certain aspects of this disclosure. A controller 502 may receive a feedback signal filtered or otherwise processed by a conditioning circuit 508. The controller may control the operation of a driver circuit 504 that provides an alternating current to a resonant circuit 506 that may be represented by a circuit that includes capacitor 512 and inductor 514. The resonant circuit 506 may also be referred to herein as a tank circuit, LC tank circuit, or LC tank, and the voltage 516 measured at an LC node 510 of the resonant circuit 506 may be referred to as the tank voltage.

The wireless transmitter 500 may be used by a charging device to determine whether a compatible device has been placed on a charging surface of a wireless charging device. For example, the charging device may determine that a compatible device has been placed on the charging surface by sending an intermittent test signal (active or digital ping) through the wireless transmitter 500, where the resonant circuit 506 may detect or receive encoded signals when a compatible device responds to the test signal. The charging device may be configured to activate one or more coils in at least one charging cell after determining receipt of a response signal defined by standard, convention, manufacturer or application. In some examples, the compatible device responds to a ping by communicating received signal strength such that the charging device can find an optimal charging cell to be used for charging the compatible device.

Passive device discovery techniques, including certain techniques disclosed herein, can determine that a chargeable device has been placed on the charging surface using test signals that do not require an active response from the chargeable device. A passive device discovery technique may involve transmission of a pulse through the surface of the charging device in order to stimulate a response that is indicative of the presence or absence of a chargeable device. In one example, a processing circuit may monitor the voltage and/or current measured or observed at the LC node 510 within the charging device to identify the presence of a receiving coil placed in proximity to the charging surface of the wireless charging device. Circuits are often provided in wireless charging devices to measure voltage at the LC node 510 or to measure the current in the LC network. These voltage and current measurements may be monitored for power regulation purposes or, in some instances, to support communication between devices. The wireless transmitter 500 in FIG. 5 illustrates measurement of voltage at the LC node 510 is monitored. Current may additionally or alternatively be monitored to support passive ping when a short pulse is provided to the resonant circuit 506. In the voltage example, a response of the resonant circuit 506 to a passive ping (initial voltage Vo) may be represented by the voltage (Vic) at the LC node 510, such that:

$${V}_{L C} = {V}_{0} {e}^{- ( \frac{ω}{2 Q} ) t} . \qquad ( Eq . 1 )$$

According to certain aspects disclosed herein, coils in one or more charging cells may be selectively activated to provide an optimal electromagnetic field for charging a compatible device. In some instances, coils may be assigned to charging cells, and some charging cells may overlap other charging cells. In the latter instances, the optimal charging configuration may be selected at the charging cell level. In other instances, charging cells may be defined based on placement of a device to be charged on a surface of the charging device. In these other instances, the combination of coils activated for each charging event can vary. In some implementations, a charging device may include a driver circuit that can select one or more cells and/or one or more predefined charging cells for activation during a charging event.

Certain aspects of this disclosure relate to the measurement or monitoring of characteristics of the chargeable device in order to detect the presence or absence of a chargeable device. In one aspect, location of the chargeable device may be determined relative to one or more transmitting coils that provide a charging surface of the chargeable device. In some instances, charging device may determine absolute distance or alignment of the chargeable device from the transmitting coils and/or multi-dimensional alignment of the chargeable device with respect to the transmitting coils.

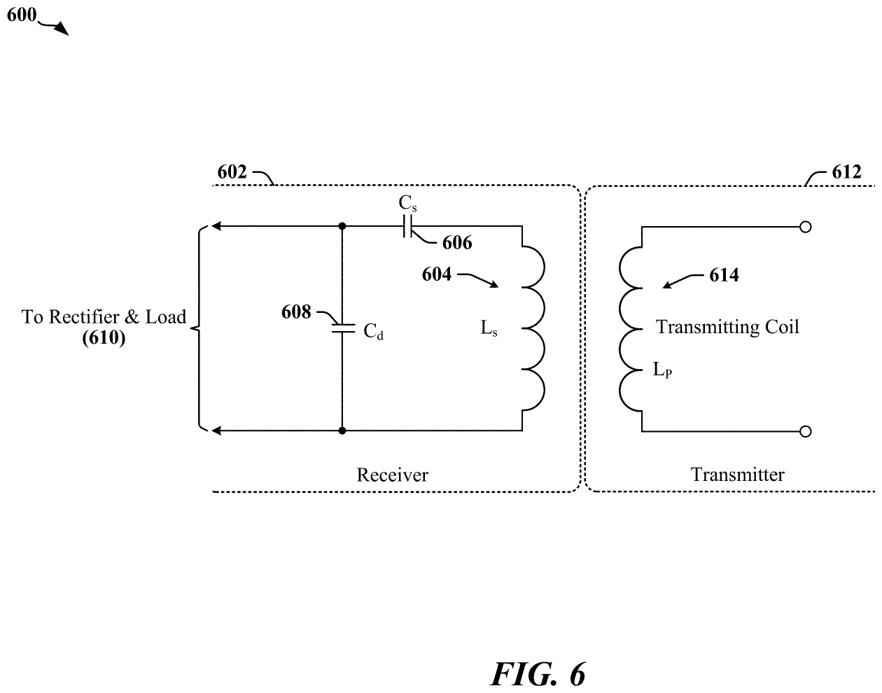

In certain aspects of the disclosure, characteristics of the chargeable device may be measured or monitored using resonant reflection. Resonant reflection exploits resonance in a power receiving circuit provided in the chargeable device. FIG. 6 illustrates an example of wireless charging in a system 600 that is compatible with the Qi standard and includes a receiving circuit 602 and a charging circuit 612. The receiving circuit 602 includes a receiving coil 604 that operates as the secondary of a transformer, the primary of the transformer being provided by a transmitting coil 614 in the charging circuit 612. The receiving coil 604 has an inductance (Lₛ). The receiving circuit 602 further includes a series resonant capacitor 606 that has a capacitance (Cₛ) chosen based on the inductance of the receiving coil 604, and which may be selected to tune the receiving circuit 602 to the frequency of the charging flux provided by the transmitting coil 614. In one example, the frequency of the charging flux is nominally 100 kHz. Accordingly, a first resonant frequency (fₛ) the receiving circuit 602 may be stated as:

$${f}_{s} = \frac{1}{2 π \cdot \sqrt{{L}_{s} \cdot {C}_{s}}} = 100 kHz .$$

The Qi standard specifies that a detection capacitor 608 is to be provided in parallel with the receiving coil 604. The detection capacitor 608 has a capacitance (C_{d}) chosen based on the inductance of the receiving coil 604 and provides a detection resonant circuit that resonates at a nominal 1 MHz. The detection resonant circuit of the receiving circuit 602 has a second resonant frequency (f_{d}) that may be stated as:

$${f}_{d} = \frac{1}{2 π \cdot \sqrt{{L}_{s} \cdot {( \frac{1}{{C}_{s}} + \frac{1}{{C}_{d}} )}^{- 1}}} = 1000 kHz .$$

While the detection resonant circuit is defined by Qi standards, it is typically unused in conventional charging systems.

According to certain aspects of the disclosure, a charging device may transmit an excitation signal that causes the detection resonant circuit to resonate and to reflect or re-radiate the energy of the excitation signal at the 1 MHz resonant frequency. For example, a charging circuit 612 may transmit an excitation flux with a frequency that can be measured at or close to 1 MHz, and a receiver in a chargeable device equipped with a resonant circuit tuned to 1 MHz will re-radiate this energy back to the charging circuit 612 at a meaningful or measurable magnitude. For the purposes of this disclosure, a chargeable device equipped with a resonant circuit tuned to 1 MHz may be referred to as a Qi compatible chargeable device, a Qi compatible device or simply as a compatible device. Chargeable devices and other devices or objects that are not compliant or compatible with Qi standards are not expected to respond to the 1 MHz excitation signal. Certain chargeable devices that are not Qi compliant may be adapted to respond to the 1 MHz excitation signal when able to receive power from the wireless charging device.

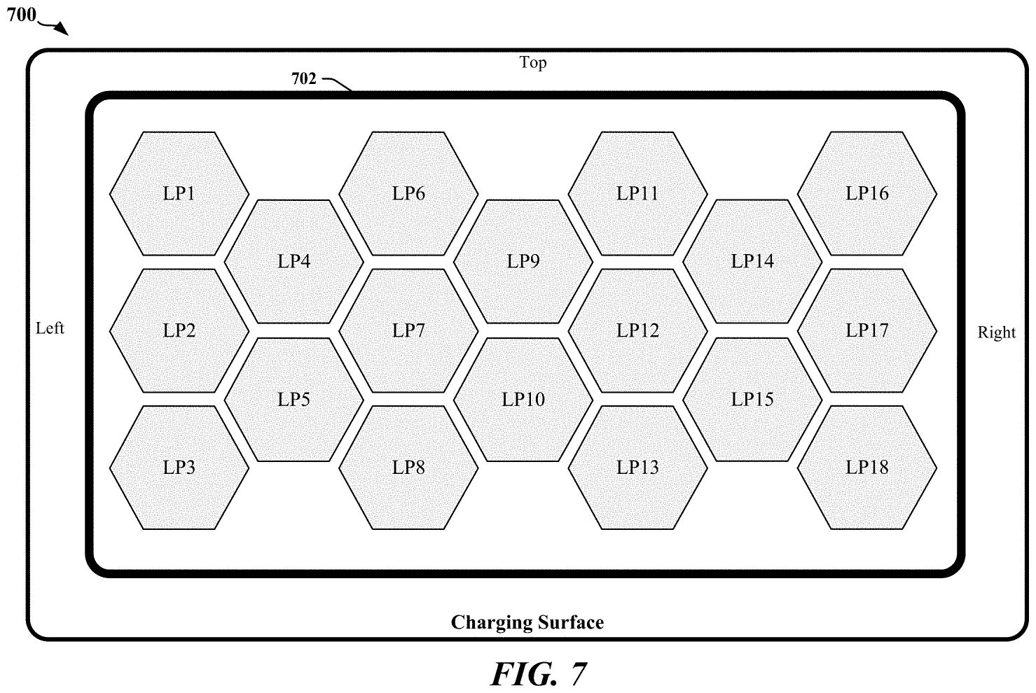

FIG. 7 illustrates an example of a charging surface 700 in a wireless charger that includes an excitation coil 702 that can detect the presence of a chargeable device placed on or near the charging surface 700. The excitation coil 702 may be provided around one or more charging coils (LP1-LP18) associated with the charging surface 700. In some examples, the excitation coil 702 encloses an area of the charging surface 700 that includes some or all of the charging coils (LP1-LP18). In one example, the excitation coil 702 borders or surrounds all of the charging coils provided in the charging surface 700. In another example, the excitation coil 702 borders or surrounds individual charging coils or groups of charging coils. For instance, the excitation coil 702 may border or surround a charging zone marked or otherwise identified on the charging surface 700, where an excitation coil 702 is configured to track or define the outer limits of a charging zone to be monitored using the resonant reflection techniques disclosed herein.

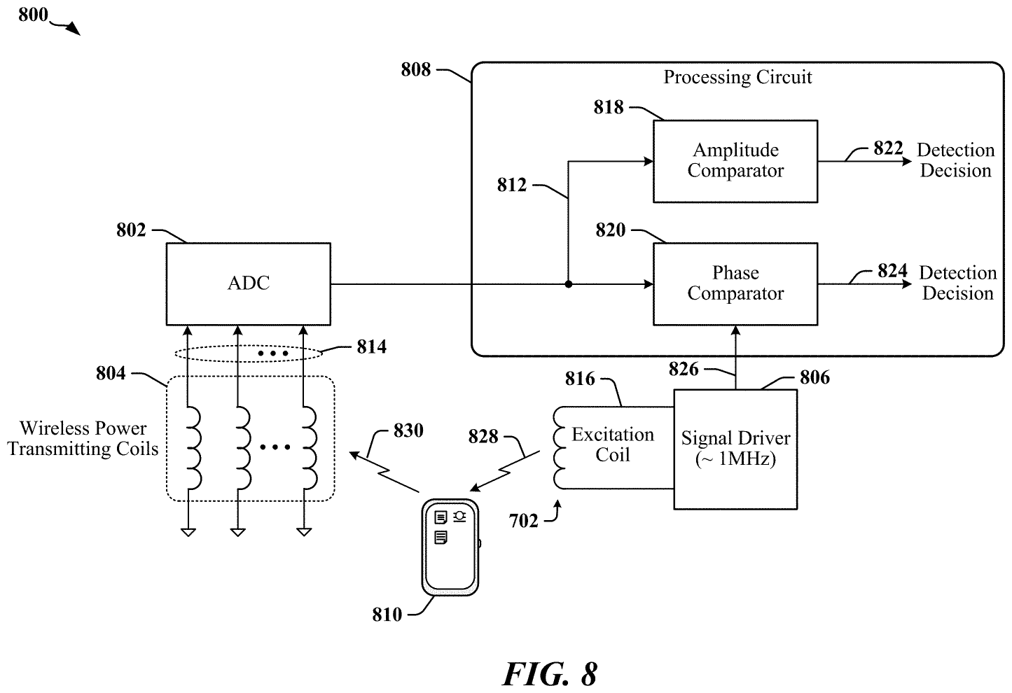

FIG. 8 illustrates a first example of a detection circuit 800 configured to detect a compatible chargeable device 810 in accordance with certain aspects of this disclosure. The detection circuit 800 may be provided within a wireless charging device. In some examples, the detection circuit 800 may be provided in a wireless charging device that provides a charging surface similar to the charging surface 700 illustrated in FIG. 7. The detection circuit 800 may include a processing circuit 808 that is coupled to a single excitation coil 702. In some examples, the processing circuit 808 may be coupled to more than one excitation coil 702. In some examples, the detection circuit 800 may be one of multiple detection circuits provided in a wireless charging device.

In some implementations, the detection circuit 800 includes a signal driver circuit 806 that provides an excitation signal 816 configurable to cause the excitation coil 702 to transmit an electromagnetic flux 828. The electromagnetic flux 828 may be referred to as an excitation flux. The excitation signal 816 is provided at or near the resonant frequency of a detection resonant circuit in a compatible or identifiable chargeable device 810. In one example, the chargeable device 810 may be compatible when it has a power receiving circuit that complies with Qi standards (see FIG. 6, for example). In another example, a chargeable device 810 may be compatible or identifiable when it has a power receiving circuit that resonates at the frequency of the excitation signal 816, which may be configured or selected using the signal driver circuit 806. In various implementations, the excitation signal 816 has a nominal frequency of 1 MHz.

The electromagnetic flux 828 transmitted by the excitation coil 702 may excite a receiving coil in the chargeable device 810. Transmitting coils 804 located in the charging surface 700 of the wireless charging device may be affected by the presence of a resonant circuit and/or may detect the electromagnetic flux 828 transmitted by the excitation coil 702. In some instances, the charging device may respond to a reflected flux 830 transmitted by the chargeable device 810 when it is located on or near the charging surface 700. The detection circuit 800 may identify the presence or location of the chargeable device 810 based on the power, amplitude, signal gain, or phase shift of a reflected flux 830 transmitted from the power receiving circuit in the chargeable device 810. The reflected flux 830 may be detected by one or more of the transmitting coils 804 in the charging surface 700.

The detection circuit 800 may determine that the chargeable device 810 is present when the magnitude of power or a phase shift is attributable to resonance and is consistent with resonance in a power receiving circuit in the chargeable device 810 at the frequency of the excitation signal 816. A characteristic 814 of the transmitting coil 804 may be monitored to determine when the chargeable device 810 is compatible and has been placed on or near the charging surface. The characteristic 814 may correspond to current flowing in a transmitting coil 804 or a tank voltage associated with the transmitting coil 804. With reference to the wireless transmitter 500 illustrated in FIG. 5, the characteristic may be represented by a measurement taken at the LC node 510 of the resonant circuit 506. In one example, the characteristic may be represented by current, or changes in current, flowing through the inductor 514. In another example, the characteristic may be represented by voltage, or changes in voltage, measured across the inductor 514. In another example, the characteristic may be represented by resonant frequency, or changes in resonant frequency of the resonant circuit 506 calculated or otherwise obtained using a series of measurements of current flow through the inductor 514 or measurements of voltage across the inductor 514. In some examples, an analog-to-digital converter (the ADC 802) may be used to sample and quantify current or voltage in the resonant circuit 506 and to provide a multibit signal 812 that provides a digital representation of the time-series of measurements of current or tank voltage associated with the inductor 514, which may have an inductance that includes the inductance of the transmitting coils 804.

The multibit signal 812 is provided to the processing circuit 808 that includes circuits or that implements modules that operate as comparators 818, 820 configured to detect differences between the observed characteristics 814 as represented by the multibit signal 812 and one or more reference signals. The reference signals may represent state of the transmitting coil 804 when no chargeable device is present.

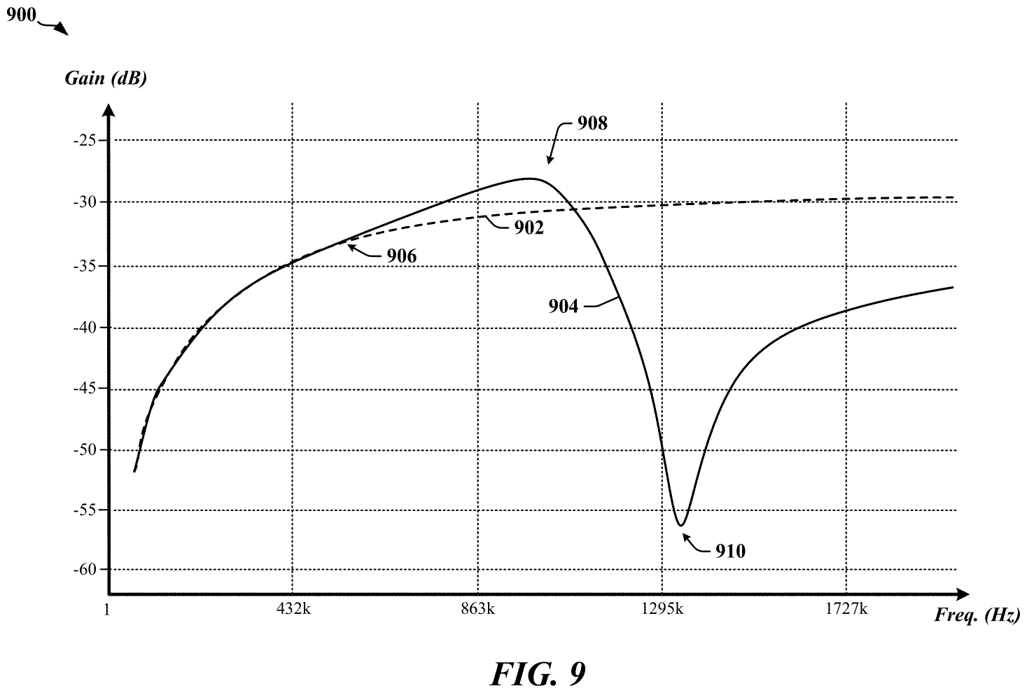

FIG. 9 is a response diagram 900 that illustrates frequency responses 902, 904 that may be observed at a transmitting coil 804 when an excitation signal 816 is transmitted over a range of frequencies. The first frequency response 902 illustrates the response expected to be observed at one or more of the transmitting coils 804 when no object is located near the charging surface 700 of a wireless charger, or when an object placed on the charging surface 700 does not have a dual-resonant power receiving circuit. The second frequency response 904 illustrates the response expected to be observed at one or more of the transmitting coils 804 when an object located near the charging surface 700 in a wireless charger has a dual-resonant power receiving circuit, and where a detection circuit is configured to resonate at a nominal 1 MHz frequency. The frequency responses 902, 904 begin to diverge at higher frequencies (e.g., f>500 kHz) and a marked difference in gain is observed near the 1 MHz frequency, with a maximum difference 910 being observed at a frequency greater than 1 MHz. The gain in the second frequency response 904 initially increases to a maximum positive difference 908 with respect to the first frequency response 902 and drops to the maximum difference 910, which is a negative difference with respect to the first frequency response 902. The peak response in gain may be observed at a frequency that is different from the nominal resonant frequency of the detection circuit in the chargeable device because the coupling of a transmitting coil in the charging device with the receiving coil affects the inductance in the detection circuit and modifies the resonant frequency of the detection circuit.

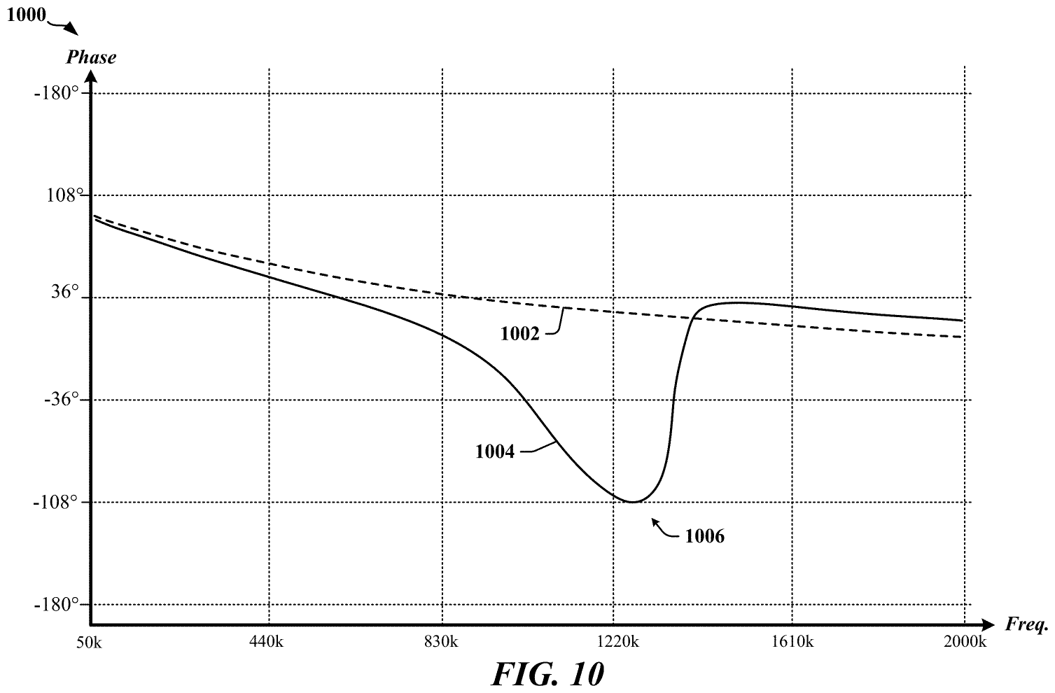

FIG. 10 is a response diagram 1000 that illustrates phase responses 1002, 1004 corresponding to phase difference between a reflected or retransmitted signal and the excitation signal 816 over a range of frequencies. The first phase response 1002 illustrates the response expected to be observed at one or more of the transmitting coils 804 when no object is located near the charging surface 700 in a wireless charger, or when an object placed on the charging surface 700 does not have a dual-resonant power receiving circuit. The second phase response 1004 illustrates the response expected to be observed at one or more of the transmitting coils 804 when an object located near the charging surface 700 in a wireless charger has a dual-resonant power receiving circuit, whereby a detection circuit is configured to resonate at a nominal 1 MHz frequency. A maximum difference 1006 is observed at a frequency greater than 1 MHz. The peak difference in phase shift between the phase responses 1002, 1004 may be observed at a frequency that is different from the nominal resonant frequency of the detection circuit in the chargeable device because the coupling of a transmitting coil in the charging device with the receiving coil affects the inductance in the detection circuit and modifies the resonant frequency of the detection circuit.

The differences between frequency responses 902, 904 and phase responses 1002, 1004 can be used by the detection circuit 800 of FIG. 8 to determine when a compatible chargeable device (e.g., the chargeable device 810) is placed or present on a charging surface 700 in a wireless charger. The processing circuit 808 may include or provide an amplitude comparator 818 configured to compare the multibit signal 812 that represents the time-series of measurements of current or tank voltage associated with the transmitting coils 804 with a reference signal or threshold. In one example, the reference signal may represent the amplitude of a reflected signal when the excitation signal 816 has a frequency where comparable gain is expected in the frequency responses 902, 904. The trajectory of the first frequency response 902 (no object present) can be expected to be increasing or substantially flat, and a drop in gain may indicate the presence of a compatible chargeable device 810. The reference signal may be obtained during a search procedure. In some instances, the reference signal may be used to set threshold levels for one or more of the transmitting coils 804 that can be used in multiple searches multiple searches.

The processing circuit 808 may include or provide a phase comparator 820 configured to compare the phase of a multibit signal 812 that represents the time-series of measurements of current or tank voltage associated with the phase 826 of the excitation signal 816. The phase comparator 820 may be further configured to determine that phase shift difference has exceeded a threshold difference or that the rate of change of phase shift exceeds a threshold rate of change.

The frequency responses 902, 904 and phase responses 1002, 1004 show that presence of a compatible chargeable device causes large differences in both the frequency responses 902, 904 and the phase responses 1002, 1004. The presence of a compatible chargeable device may result in the maximum difference in frequency responses 902, 904 occurring at a frequency that is different from the frequency at which the maximum difference in phase responses 1002, 1004 occurs. Moreover, the maximum differences in frequency responses 902, 904 and phase responses 1002, 1004 typically do not occur at exactly 1 MHz due to the change in resonant frequency caused by coupling between the transmitting coil in the charging device and the receiving coil in a chargeable device 810.

In certain implementations, the location of the chargeable device 810 can be estimated or ascertained based on the responses measured for multiple transmitting coils 804. In one example, a transmitting coil 804 closest to the chargeable device 810 may produce the greatest amplitude or phase shift in a detected, reflected signal. In another example, a transmitting coil 804 closest to the chargeable device 810 may produce the greatest change in amplitude or change in phase shift in a detected, reflected signal relative to a reference signal. In some instances, the reference signal used for each transmitting coil 804 may be a signal captured for the transmitting coil 804 during a calibration procedure. In some instances, the reference signal used for each transmitting coil 804 may be captured during a search procedure at a frequency that is not expected to provoke a resonant response in the compatible chargeable device 810.

In some implementations, the processing circuit 808 may include or provide both an amplitude comparator 818 and a phase comparator 820 to improve reliability of detection of the presence of chargeable device 810. The generation of two detection decisions 822, 824 can improve reliability and can accommodate changes in the resonant frequency of the detection circuit. Frequency dithering may be used to further improve detection. Frequency dithering is conventionally employed to improve signal-to-noise ratio (SNR) in power supplies by spreading the noise spectrum. The use a variable frequency excitation signal 816 can improve detection of the presence of chargeable device 810 when such presence can modify the resonant frequency of the detection circuit to an unpredictable extent, where changes in the resonant frequency can depend upon proximity and degree of overlap of power transmitting and power receiving coils, for example. Frequency dithering techniques can be applied to reduce the uncertainty in detection, which may be quantified as a form of SNR.

Some implementations may use a single excitation frequency to reduce complexity at the expense of increased uncertainty in detection. Some implementations may use a single detection metric—amplitude or phase—to reduce complexity in the charging circuit. The monitoring and measurement of both phase shift and amplitude of reflected signals can increase detection circuit sensitivity and reliability of the detection.

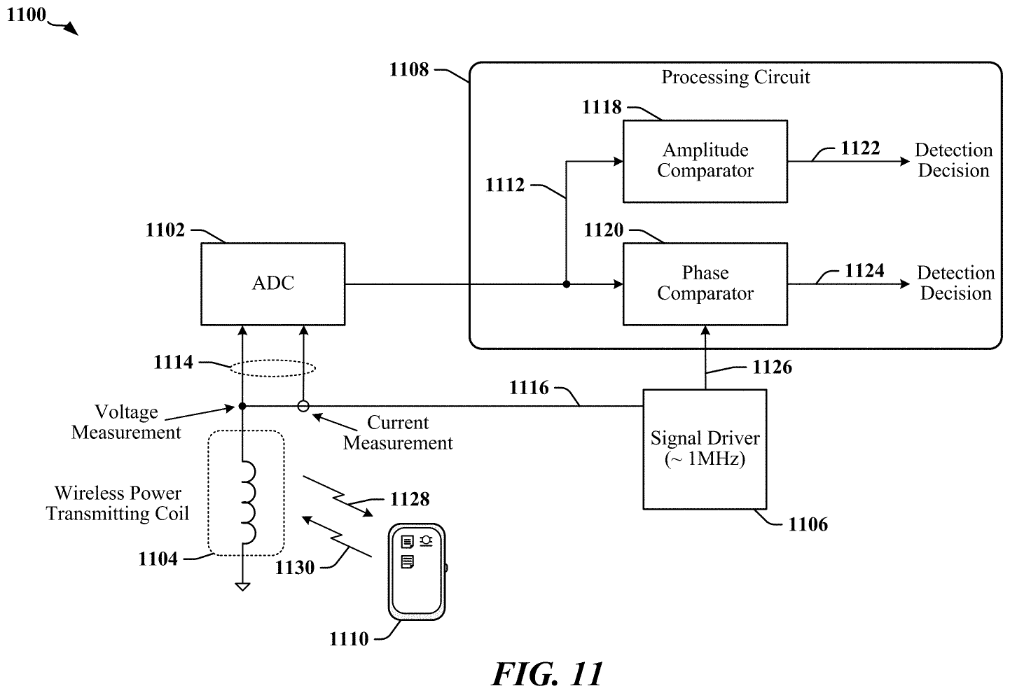

FIG. 11 illustrates a second example of a detection circuit 1100 configured to detect compatible chargeable devices 1110 in accordance with certain aspects of this disclosure. The detection circuit 1100 may be provided in a wireless charger. In one example described herein, the detection circuit 1100 may be provided in a wireless charger that provides the charging surface 700 illustrated in FIG. 7, and uses one or more power transmitting coils 1104 to transmit an excitation signal 1116. A power transmitting coil 1104 that transmits the excitation signal 1116 may also detect any signals that are reflected in response to the excitation signal 1116.

In the illustrated example, the detection circuit 1100 includes a signal driver 1106 that provides the excitation signal 1116 to a power transmitting coil 1104. The excitation signal 1116 causes the power transmitting coil 1104 to transmit an electromagnetic flux 1128. The excitation signal 1116 has a frequency that close to the nominal resonant frequency of a detection resonant circuit in a compatible or identifiable chargeable device. In one example, a chargeable device may be compatible when it has a power receiving circuit that complies with Qi standards (see FIG. 6, for example). In another example, a chargeable device may be compatible or identifiable when it has a power receiving circuit that resonates at the frequency of the excitation signal 1116 configured or selected using the signal driver 1106. In various implementations, the excitation signal 1116 has a nominal frequency of 1 MHz.

The electromagnetic flux 1128 transmitted by a power transmitting coil 1104 may excite a receiving coil in a chargeable device 1110. For example, a power transmitting coil 1104 located in the charging surface 700 may be affected by the presence of a resonant circuit and/or by a reflected flux 1130 transmitted by a chargeable device 1110 located on or near the charging surface 700. The detection circuit 1100 may identify the presence or location of the chargeable device 1110 based on the amplitude or phase shift measured in the power transmitting coil 1104. In some implementations, the amplitude and/or phase of a tank voltage or current associated with the power transmitting coil 1104 may be monitored to determine magnitude, phase or changes in magnitude or phase of voltage or current attributable to resonance in a power receiving circuit in the chargeable device 1110 at or near the frequency of the excitation signal 1116.

A characteristic 1114 of the power transmitting coil 1104 may be monitored to determine when a compatible chargeable device 1110 has been placed near the charging surface. The characteristic 1114 may correspond to current flowing in a power transmitting coil 1104 or amplitude of a tank voltage associated with the power transmitting coil 1104. In one implementation, an analog-to-digital converter (the ADC 1102) may be used to sample and measure one or more characteristics 1114 and to provide a multibit signal 1112 that provides a digital representation of the time-series of measurements of current or tank voltage associated with the power transmitting coil 1104.

The multibit signal 1112 is provided to a processing circuit 1108 that includes circuits or implements modules that operate as comparators 1118, 1120 configured to detect differences between the observed characteristics 1114 as represented by the multibit signal 1112 and one or more reference signals. The reference signals may represent state of the power transmitting coils 1104 when no chargeable device is present.

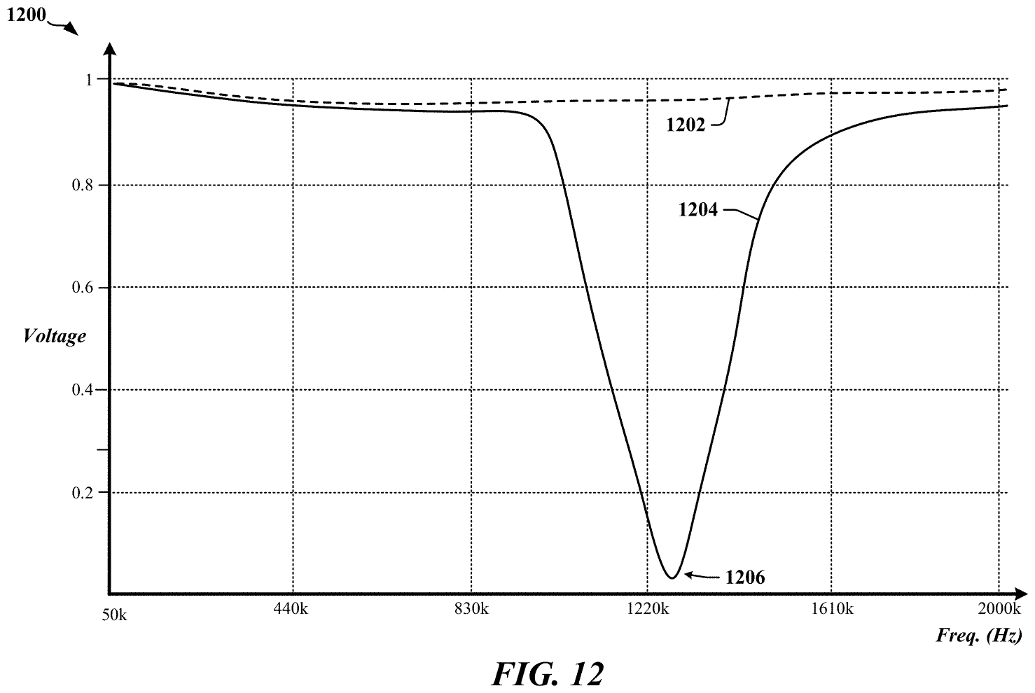

FIG. 12 is a response diagram 1200 that illustrates frequency responses 1202, 1204 that may be observed at a power transmitting coil 1104 when an excitation signal 1116 is transmitted over a range of frequencies. The frequency responses 1202, 1204 plot voltage or current amplitude against frequency of the excitation signal 1116 and measurements may be taken at the power transmitting coil 1104. The first frequency response 1202 illustrates the response observed at the power transmitting coil 1104 when no object is located near the charging surface 700 in a wireless charger, or when an object placed on the charging surface 700 does not have a dual-resonant power receiving circuit. The second frequency response 1204 illustrates the response observed at the power transmitting coil 1104 when an object located near the charging surface 700 in a wireless charger has a dual-resonant power receiving circuit, whereby a detection circuit in the compatible chargeable device 1110 is configured to resonate at a nominal 1 MHz frequency. The frequency responses 1202, 1204 exhibit a maximum difference 1206 at a frequency greater than 1 MHz.

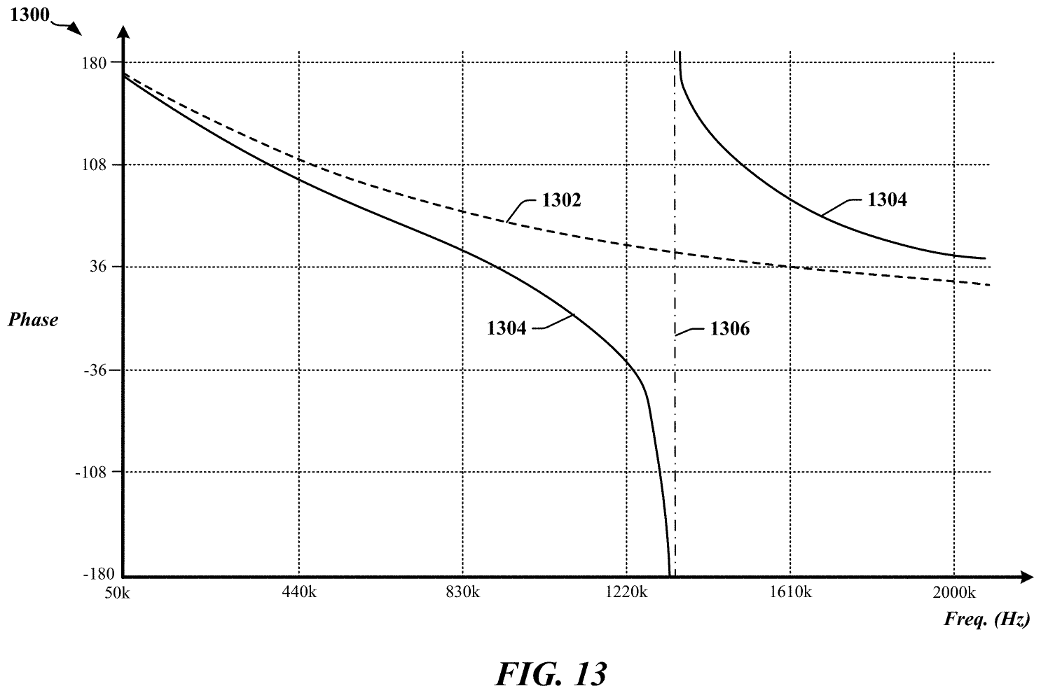

FIG. 13 is a response diagram 1300 that illustrates phase responses 1302, 1304 observed at a power transmitting coil 1104 when an excitation signal 1116 is transmitted over a range of frequencies. The frequency responses 1202, 1204 phase difference in voltage or current amplitude against frequency of excitation signal 1116 and may be observed at the power transmitting coil 1104. The phase difference may be attributable to a reflected or retransmitted signal or the effect of a resonant circuit in a nearby chargeable device 1110 on the charging circuit that includes the power transmitting coil 1104.

The first phase response 1302 illustrates the response observed at the power transmitting coil 1104 when no object is located near the charging surface 700 in the wireless charger, or when an object placed on the charging surface 700 does not have a dual-resonant power receiving circuit. The second phase response 1304 illustrates the response observed at the power transmitting coil 1104 when an object located near the charging surface 700 in a wireless charger has a dual-resonant power receiving circuit, whereby a detection circuit is configured to resonate at a nominal 1 MHz frequency. A maximum difference is observed at a frequency 1306 greater than 1 MHz. The peak difference in phase shift between the phase responses 1302, 1304 may be observed at a frequency that is different from the nominal resonant frequency of the detection circuit in the chargeable device because the coupling of a transmitting coil in the charging device with the receiving coil affects the inductance in the detection circuit and modifies the resonant frequency of the detection circuit.

The differences between frequency responses 902, 904 and phase responses 1302, 1304 can be used by the detection circuit 1100 of FIG. 11 to determine when a compatible chargeable device 1110 is placed or present on a charging surface 700 in a wireless charger. The processing circuit 1108 may include or provide an amplitude comparator 1118 configured to compare the multibit signal 1112 that represents the time-series of measurements of current or tank voltage associated with the power transmitting coils 1104 with a reference signal or threshold. The trajectory of the first frequency response 1202 (no object present) can be expected to be substantially flat, and a drop in gain may indicate the presence of a compatible chargeable device 1110. The reference signal may be obtained during a search procedure. In some instances, the reference signal may be used to set threshold levels for one or more of the power transmitting coils 1104 that can be used in multiple searches multiple searches.

The processing circuit 1108 may include or provide a phase comparator 1120 configured to compare the phase of multibit signal 1112 that represents the time-series of measurements of current or tank voltage associated with the phase 1126 of the excitation signal 1116. The phase comparator 1120 may be further configured to determine that phase shift difference has exceeded a threshold difference or that the rate of change of phase shift exceeds a threshold rate of change.

The frequency responses 902, 904 and phase responses 1302, 1304 show that presence of a compatible chargeable device 1110 causes large differences in both the frequency responses 902, 904 and the phase responses 1302, 1304. The presence of a compatible chargeable device 1110 may result in the maximum difference in frequency responses 902, 904 occurring at a frequency that is different from the frequency at which the maximum difference in phase responses 1302, 1304 occurs. Moreover, the maximum differences in frequency responses 902, 904 and phase responses 1302, 1304 typically do not occur at exactly 1 MHz due to the change in resonant frequency caused by coupling between the transmitting coil in the charging device and the receiving coil in a chargeable device 1110.

In certain implementations, the location of a compatible chargeable device 1110 can be estimated or ascertained based on the responses measured for multiple power transmitting coils 1104. In one example a power transmitting coil 1104 closest to the compatible chargeable device 1110 may produce the greatest amplitude or phase shift in a detected, reflected signal. In another example, a power transmitting coil 1104 closest to the compatible chargeable device 1110 may produce the greatest change in amplitude or change in phase shift in a detected, reflected signal relative to a reference signal. In some instances, the reference signal used for each power transmitting coil 1104 may be a signal captured for the power transmitting coil 1104 during a calibration procedure. In some instances, the reference signal used for each power transmitting coil 1104 may be captured during a search procedure at a frequency that is not expected to provoke a resonant response in the compatible chargeable device 1110.

In some implementations, the processing circuit 1108 may include or provide both an amplitude comparator 1118 and a phase comparator 1120 to improve reliability of detection of the presence of compatible chargeable device 1110. The generation of two detection decisions 1122, 1124 can improve reliability and accommodate changes in the resonant frequency of the detection circuit. Frequency dithering may be used to further improve detection. Frequency dithering is conventionally employed to improve SNR in power supplies by spreading the noise spectrum. The use a variable frequency excitation signal 1116 can improve detection of the presence of compatible chargeable device 1110 when such presence can modify the resonant frequency of the detection circuit to an unpredictable extent, where changes in the resonant frequency can depend upon proximity and degree of overlap of power transmitting and power receiving coils, for example. Frequency dithering techniques can be applied to reduce the uncertainty in detection, which may be quantified as a form of SNR.

Some implementations may use a single excitation frequency to reduce complexity at the expense of increased uncertainty in detection. Some implementations may use a single detection metric to reduce complexity in charging circuit. The monitoring and measurement of both phase shift and amplitude of reflected signals can increase detection circuit sensitivity and reliability of the detection.

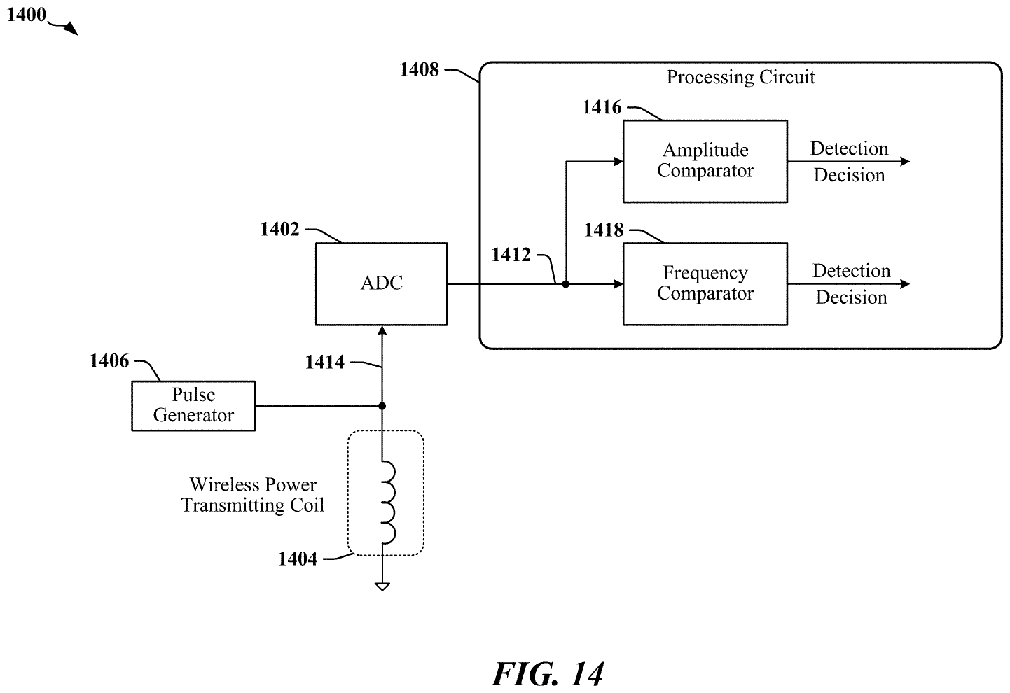

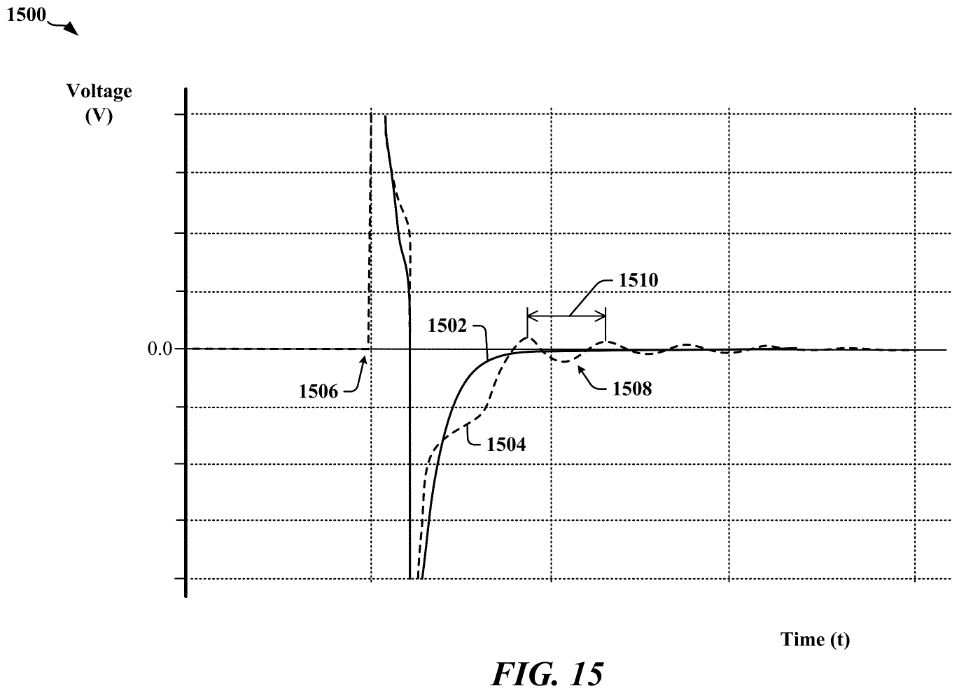

FIG. 14 illustrates a third example of a detection circuit 1400 configured to detect compatible chargeable devices in accordance with certain aspects of this disclosure. FIG. 15 is a diagram 1500 that illustrates responses 1502, 1504 observed at a power transmitting coil 1404 after a pulse has been transmitted in an excitation signal 1414. The detection circuit 1400 may be provided in a wireless charger. In one example described herein, the detection circuit 1400 may be provided in a wireless charger that provides the charging surface 700 illustrated in FIG. 7, and that uses one or more power transmitting coils 1404 to transmit an excitation signal 1414. A power transmitting coil 1404 that transmits the excitation signal 1414 may also detect any signals that are reflected in response to the excitation signal 1414.

In the illustrated example, the detection circuit 1400 includes a pulse generator 1406 that provides a short pulse in the excitation signal 1414. The excitation signal 1414 is provided to a power transmitting coil 1404 and may be configured to stimulate a resonant circuit in a compatible or identifiable chargeable device. In one example, a chargeable device may be compatible when it has a power receiving circuit that complies with Qi standards (see FIG. 6, for example). In another example, a chargeable device may be compatible or identifiable when it has a power receiving circuit that resonates at a nominal frequency of 1 MHz.

The excitation signal 1414 may cause the power transmitting coil 1404 to transmit an electromagnetic flux that may be referred to herein as an excitation flux. The excitation flux may be reflected by a receiving circuit in a chargeable device. For example, a power transmitting coil 1404 located in the charging surface 700 may be coupled with a receiving coil in a chargeable device located on or near the charging surface 700. The detection circuit 1400 may identify the presence or location of the chargeable device based on the delay between time of transmission 1506 of the pulse and a response received from the chargeable device. In certain implementations, a response received from a compatible chargeable device includes ringing 1508 at the resonant frequency of a resonant circuit in the chargeable device. The detection circuit 1400 may be configured to determine the period of oscillation 1510 of the ringing in order to determine the resonant frequency of the resonant circuit in the chargeable device. A compatible chargeable device may resonate at or near the nominal frequency of 1 MHz. A characteristic of the power transmitting coil 1404 may be monitored to determine when a compatible chargeable device has been placed near the charging surface. The characteristic may correspond to amplitude of current flowing in a power transmitting coil 1404 or to the altitude of the tank voltage associated with the power transmitting coil 1404. In one implementation, an analog-to-digital converter (the ADC 1402) may be used to sample and measure one or more characteristics and to provide a multibit signal 1412 that provides a digital representation of the time-series of measurements of current or tank voltage associated with the power transmitting coil 1404.

The multibit signal 1412 is provided to a processing circuit 1408 that includes circuits or implements modules that operate as comparators 1416, 1418 configured to detect differences between the observed characteristics as represented by the multibit signal 1412 and one or more reference signals. The reference signals may represent state of the power transmitting coils 1404 when no chargeable device is present.

The responses 1502, 1504 in FIG. 15 plot voltage or current amplitude against time and may be observed at the power transmitting coil 1404. The first response 1502 illustrates the response observed at a power transmitting coil 1404 when no object is located near the charging surface 700 in a wireless charger, or when an object placed on the charging surface 700 does not have a dual-resonant power receiving circuit. The second response 1504 illustrates the response observed at a power transmitting coil 1404 when an object located near the charging surface 700 in a wireless charger has a dual-resonant power receiving circuit, whereby a detection circuit in the chargeable device is configured to resonate at a nominal 1 MHz frequency. The second response 1504 includes ringing 1508 at a resonant frequency of the object.

The processing circuit 1408 may include or provide an amplitude comparator 1416 configured to calculate and/or compare the amplitude of the multibit signal 1412 to one or more thresholds to detect a reflected pulse. In some instances, the frequency comparator 1418 may be replaced or supplemented with a notch filter, band pass filter or high pass filter that facilitates or enables detection of the resonant frequency in a reflected signal. Time information obtained from the processing circuit 1408 may be used to estimate the distance of the chargeable device from the power transmitting coil 1404.

The processing circuits 808, 1108, 1408 may include a DSP or other processor that is configured to process the multibit signal 1412. The DSP or other processor may perform digital filtering, frequency estimation or detection, phase measurement and amplitude measurement. The DSP or other processor may be configured to perform time-domain and frequency domain calculations. In some implementations, one or more functions ay be performed using analog circuits, including filters comparators and amplifiers.

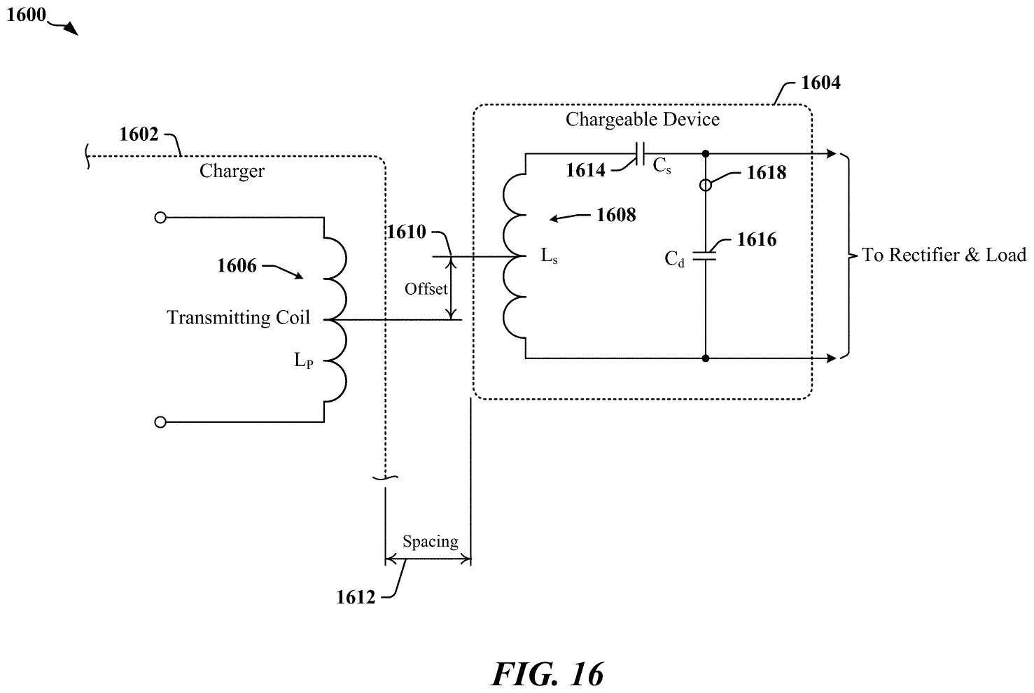

In some implementations, differences between phase and amplitude maxima or other variations in measured resonant frequency can be used to optimize a charging configuration for a charging device. FIG. 16 illustrates certain aspects of a physical configuration 1600 of devices in which a charging device 1602 and a chargeable device 1604 are proximately located, such that there is an inductive coupling between a transmitting coil 1606 in the charging device 1602 and a receiving coil 1608 in the chargeable device 1604. Maximum coupling can be accomplished when the surfaces of the charging device 1602 and the chargeable device 1604 are in flat contact and when the center of the transmitting coil 1606 and the receiving coil 1608 are coaxially aligned. In many instances, there may exist a spacing 1612 between the surfaces of the charging device 1602 and the chargeable device 1604 or the axes of the transmitting coil 1606 and the receiving coil 1608 may be offset 1610 or otherwise misaligned, resulting in a less than maximum coupling. Variances in coupling can result in changes in resonant frequency of the detection circuit of the chargeable device 1604 that includes the receiving coil 1608, the series resonant capacitor 1614, and the detection capacitor 1616.

In one aspect of this disclosure, a charging configuration for the chargeable device 1604 may be selected based on the coupling between the transmitting coil 1606 and the receiving coil 1608, which may be determined based on measurements 1618 taken from the detection circuit of the chargeable device 1604. The measurements 1618 may include tank voltage, current or frequency. In some instances, the measurements 1618 are obtained as a time series of amplitude of tank voltage or current. The tank voltage, current or frequency may be used to calculate phase shift or gain and may be used to determine a charging configuration or an operating point for one or more charging cells in the charging device 1602. The charging configuration may determine which transmitting coils 1606 are to receive a charging current during charging events, and may further define amplitude and phase of the current in each transmitting coil 1606.

In one example, the operating point may be determined from a lookup table that is used to configure magnitude and frequency of a current to be used for charging the chargeable device 1604. The chargeable device 1604 may indicate or negotiate a desired power level for wireless charging. The desired power level may be communicated or agreed through a digital ping. The charging device 1602 may use the operating point to configure a current level calculated to provide the desired power level for wireless charging. The charging device 1602 may use the operating point to configure a frequency of the used to drive the transmitting coil 1606 in order to match the resonant frequency of the receiving circuit in the charging device 1602 when the transmitting coil 1606 and the receiving coil 1608 are magnetically coupled.

### Example of a Processing Circuit

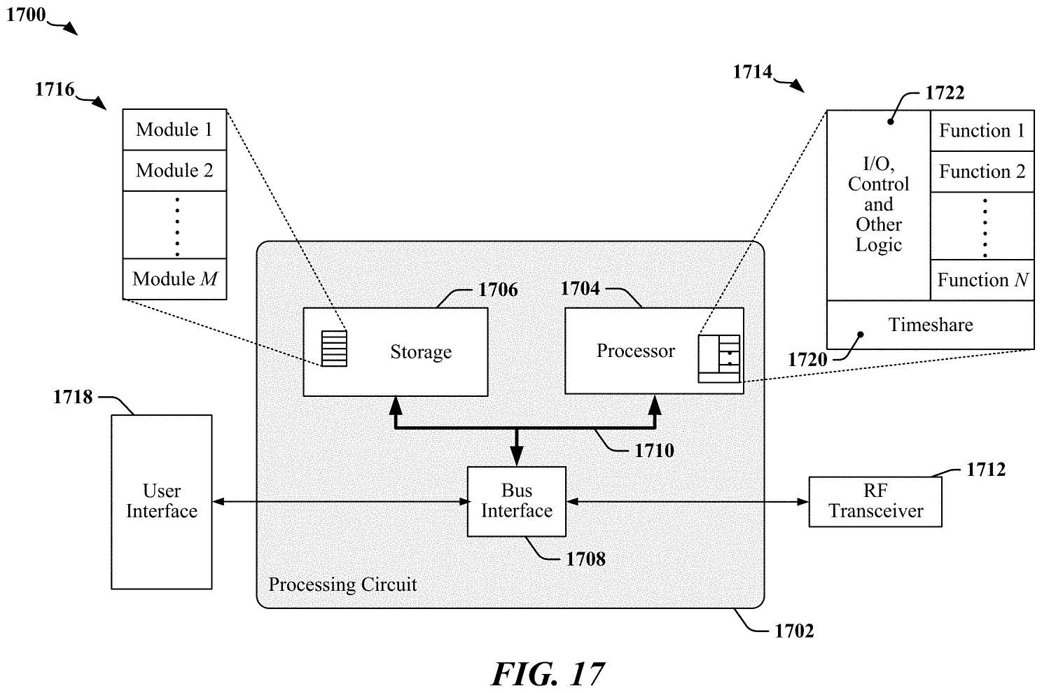

FIG. 17 illustrates an example of a hardware implementation for an apparatus 1700 that may be incorporated in a charging device or in a receiving device that enables a battery to be wirelessly charged. In some examples, the apparatus 1700 may perform one or more functions disclosed herein. In accordance with various aspects of the disclosure, an element, or any portion of an element, or any combination of elements as disclosed herein may be implemented using a processing circuit 1702. The processing circuit 1702 may include one or more processors 1704 that are controlled by some combination of hardware and software modules. Examples of processors 1704 include microprocessors, microcontrollers, DSPs, SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1704 may include specialized processors that perform specific functions, and that may be configured, augmented or controlled by one of the software modules 1716. The one or more processors 1704 may be configured through a combination of software modules 1716 loaded during initialization, and further configured by loading or unloading one or more software modules 1716 during operation.

In the illustrated example, the processing circuit 1702 may be implemented with a bus architecture, represented generally by the bus 1710. The bus 1710 may include any number of interconnecting buses and bridges depending on the specific application of the processing circuit 1702 and the overall design constraints. The bus 1710 links together various circuits including the one or more processors 1704, and storage 1706. Storage 1706 may include memory devices and mass storage devices, and may be referred to herein as computer-readable media and/or processor-readable media. The storage 1706 may include transitory storage media and/or non-transitory storage media.

The bus 1710 may also link various other circuits such as timing sources, timers, peripherals, voltage regulators, and power management circuits. A bus interface 1708 may provide an interface between the bus 1710 and one or more transceivers 1712. In one example, a transceiver 1712 may be provided to enable the apparatus 1700 to communicate with a charging or receiving device in accordance with a standards-defined protocol. Depending upon the nature of the apparatus 1700, a user interface 1718 (e.g., keypad, display, speaker, microphone, joystick) may also be provided, and may be communicatively coupled to the bus 1710 directly or through the bus interface 1708.

A processor 1704 may be responsible for managing the bus 1710 and for general processing that may include the execution of software stored in a computer-readable medium that may include the storage 1706. In this respect, the processing circuit 1702, including the processor 1704, may be used to implement any of the methods, functions and techniques disclosed herein. The storage 1706 may be used for storing data that is manipulated by the processor 1704 when executing software, and the software may be configured to implement any one of the methods disclosed herein.

One or more processors 1704 in the processing circuit 1702 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1706 or in an external computer-readable medium. The external computer-readable medium and/or storage 1706 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1706 may also include, by way of example, a carrier wave, a transmission line, and any other suitable medium for transmitting software and/or instructions that may be accessed and read by a computer. Computer-readable medium and/or the storage 1706 may reside in the processing circuit 1702, in the processor 1704, external to the processing circuit 1702, or be distributed across multiple entities including the processing circuit 1702. The computer-readable medium and/or storage 1706 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1706 may maintain and/or organize software in loadable code segments, modules, applications, programs, etc., which may be referred to herein as software modules 1716. Each of the software modules 1716 may include instructions and data that, when installed or loaded on the processing circuit 1702 and executed by the one or more processors 1704, contribute to a run-time image 1714 that controls the operation of the one or more processors 1704. When executed, certain instructions may cause the processing circuit 1702 to perform functions in accordance with certain methods, algorithms and processes described herein.

Some of the software modules 1716 may be loaded during initialization of the processing circuit 1702, and these software modules 1716 may configure the processing circuit 1702 to enable performance of the various functions disclosed herein. For example, some software modules 1716 may configure internal devices and/or logic circuits 1722 of the processor 1704, and may manage access to external devices such as a transceiver 1712, the bus interface 1708, the user interface 1718, timers, mathematical coprocessors, and so on. The software modules 1716 may include a control program and/or an operating system that interacts with interrupt handlers and device drivers, and that controls access to various resources provided by the processing circuit 1702. The resources may include memory, processing time, access to a transceiver 1712, the user interface 1718, and so on.

One or more processors 1704 of the processing circuit 1702 may be multifunctional, whereby some of the software modules 1716 are loaded and configured to perform different functions or different instances of the same function. The one or more processors 1704 may additionally be adapted to manage background tasks initiated in response to inputs from the user interface 1718, the transceiver 1712, and device drivers, for example. To support the performance of multiple functions, the one or more processors 1704 may be configured to provide a multitasking environment, whereby each of a plurality of functions is implemented as a set of tasks serviced by the one or more processors 1704 as needed or desired. In one example, the multitasking environment may be implemented using a timesharing program 1720 that passes control of a processor 1704 between different tasks, whereby each task returns control of the one or more processors 1704 to the timesharing program 1720 upon completion of any outstanding operations and/or in response to an input such as an interrupt. When a task has control of the one or more processors 1704, the processing circuit is effectively specialized for the purposes addressed by the function associated with the controlling task. The timesharing program 1720 may include an operating system, a main loop that transfers control on a round-robin basis, a function that allocates control of the one or more processors 1704 in accordance with a prioritization of the functions, and/or an interrupt driven main loop that responds to external events by providing control of the one or more processors 1704 to a handling function.

In one implementation, the apparatus 1700 includes or operates as a wireless charging device that has a battery charging power source coupled to a charging circuit, a plurality of charging cells and a controller, which may be included in one or more processors 1704. The plurality of charging cells may be configured to provide a charging surface. At least one coil may be configured to direct an electromagnetic field through a charge transfer area of each charging cell. The controller may be configured to cause the charging circuit to cause an excitation flux to be transmitted from the charging device, determine that a compatible chargeable device is available for charging by the charging device when resonance is detected in response to the excitation flux, and provide a charging current to a power transmitting coil of the charging device. The excitation flux may be transmitted in a first range of frequencies that includes a first nominal resonant frequency associated with compatible chargeable devices. The charging current may be provided in a second range of frequencies that includes a second nominal resonant frequency associated with the compatible chargeable devices. The first range of frequencies and the second range of frequencies may be separated by a third range of frequencies. In one example, the first nominal resonant frequency is defined as 1 megahertz and the second nominal resonant frequency is defined as 100 kilohertz. The first nominal resonant frequency and the second nominal resonant frequency may be defined by protocol or by a standard such as the Qi standard.

In some examples, the controller is further configured to provide an excitation signal to an excitation coil that encloses one or more power transmitting coils provided within an area of a surface of the charging device. The controller may be further configured to detect resonance based on phase or gain of a signal received by the power transmitting coil that is reflection of the excitation signal.

In some examples, the controller is further configured to provide an excitation signal to the power transmitting coil. The controller may be further configured to detect resonance based on phase or gain in a circuit that includes the power transmitting coil. In some examples, the controller is further configured to provide a pulse to a coil that transmits the excitation flux, and detect resonance based on frequency of a reflection of the pulse.

In some examples, the controller is further configured to determine a difference between frequency of the resonance and the first nominal resonant frequency, and to configure an amplitude or frequency of the charging current based on the difference.

In some implementations, the storage 1706 maintains instructions and information where the instructions are configured to cause the one or more processors 1704 to cause an excitation flux to be transmitted from the charging device, determine that a compatible chargeable device is available for charging by the charging device when resonance is detected in response to the excitation flux, and provide a charging current to a power transmitting coil of the charging device. The excitation flux may be transmitted in a first range of frequencies that includes a first nominal resonant frequency associated with compatible chargeable devices. The charging current may be provided in a second range of frequencies that includes a second nominal resonant frequency associated with the compatible chargeable devices. The first range of frequencies and the second range of frequencies may be separated by a third range of frequencies. In one example, the first nominal resonant frequency is defined as 1 megahertz and the second nominal resonant frequency is defined as 100 kilohertz. The first nominal resonant frequency and the second nominal resonant frequency may be defined by protocol or by a standard such as the Qi standard.

In some examples, transmitting the excitation flux includes providing an excitation signal to an excitation coil that encloses one or more power transmitting coils provided within an area of a surface of the charging device. The instructions may be configured to cause the one or more processors 1704 to detect resonance based on phase or gain of a signal received by the power transmitting coil that is reflection of the excitation signal.

In some examples, transmitting the excitation flux includes providing an excitation signal to the power transmitting coil. The instructions may be configured to cause the one or more processors 1704 to detect resonance based on phase or gain in a circuit that includes the power transmitting coil. The instructions may be configured to cause the one or more processors 1704 to provide a pulse to a coil that transmits the excitation flux, and detect resonance based on frequency of a reflection of the pulse. The instructions may be configured to cause the one or more processors 1704 to determine a difference between frequency of the resonance and the first nominal resonant frequency, and configure an amplitude or frequency of the charging current based on the difference.

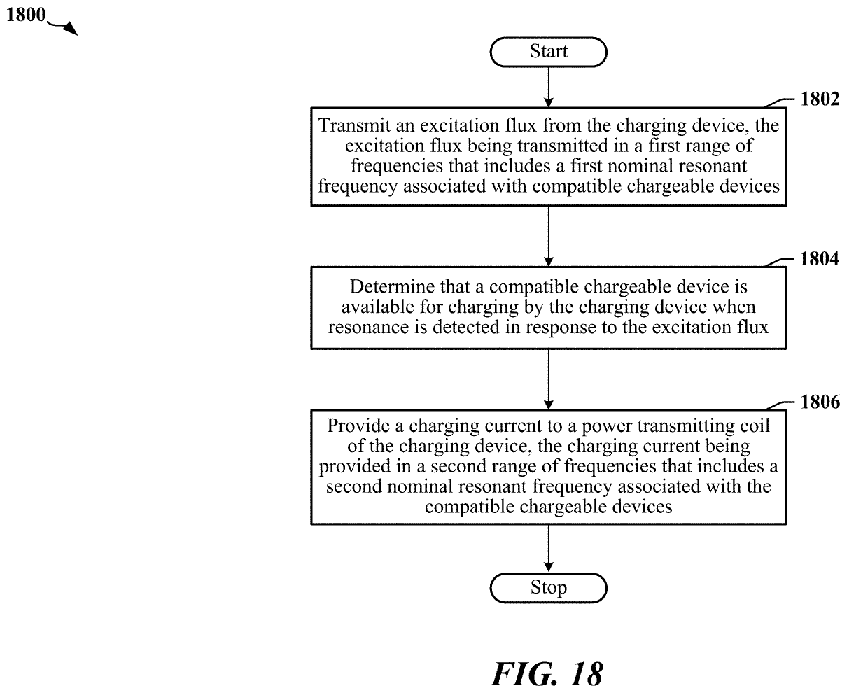

FIG. 18 is a flowchart 1800 illustrating a method for operating a charging device in accordance with certain aspects of this disclosure. The method may be performed by a DSP, processor or other controller in the charging device. At block 1802, the controller may transmit an excitation flux from the charging device. The excitation flux may be transmitted in a first range of frequencies that includes a first nominal resonant frequency associated with compatible chargeable devices. At block 1804, the controller may determine that a compatible chargeable device is available for charging by the charging device when resonance is detected in response to the excitation flux. At block 1806, the controller may provide a charging current to a power transmitting coil of the charging device. The charging current may be provided in a second range of frequencies that includes a second nominal resonant frequency associated with the compatible chargeable devices.

In some examples, the first range of frequencies and the second range of frequencies are separated by a third range of frequencies. The first nominal resonant frequency is defined as 1 megahertz and the second nominal resonant frequency is defined as 100 kilohertz.

In some examples, the controller may transmit the excitation flux by providing an excitation signal to an excitation coil that encloses one or more power transmitting coils provided within an area of a surface of the charging device. The controller may detect resonance based on phase or gain of a signal received by the power transmitting coil that is reflection of the excitation signal.

In some examples, the controller may transmit the excitation flux by providing an excitation signal to the power transmitting coil. The controller may detect resonance based on phase or gain in a circuit that includes the power transmitting coil. In some implementations, the controller may provide a pulse to a coil that transmits the excitation flux, and detect resonance based on frequency of a reflection of the pulse. In some implementations, the controller may determine a difference between frequency of the resonance and the first nominal resonant frequency, and may configure an amplitude or frequency of the charging current based on the difference.

Some implementation examples are described in the following numbered clauses:
1. A method for operating a charging device, comprising: transmitting an excitation flux from the charging device, the excitation flux being transmitted in a first range of frequencies that includes a first nominal resonant frequency associated with compatible chargeable devices; determining that a compatible chargeable device is available for charging by the charging device when resonance is detected in response to the excitation flux; and providing a charging current to a power transmitting coil of the charging device, the charging current being provided in a second range of frequencies that includes a second nominal resonant frequency associated with the compatible chargeable devices.
2. The method as described in clause 1, wherein the first range of frequencies and the second range of frequencies are separated by a third range of frequencies.
3. The method as described in clause 1 or clause 2, wherein the first nominal resonant frequency is defined as 1 megahertz and the second nominal resonant frequency is defined as 100 kilohertz.
4. The method as described in any of clauses 1-3, wherein transmitting the excitation flux comprises: providing an excitation signal to an excitation coil that encloses one or more power transmitting coils provided within an area of a surface of the charging device.
5. The method as described in clause 4, further comprising: detecting resonance based on phase or gain of a signal received by the power transmitting coil that is a reflection of the excitation signal.
6. The method as described in any of clauses 1-5, wherein transmitting the excitation flux comprises: providing an excitation signal to the power transmitting coil.
7. The method as described in clause 6, further comprising: detecting resonance based on phase or gain in a circuit that includes the power transmitting coil.
8. The method as described in any of clauses 1-7, further comprising: providing a pulse to a coil that transmits the excitation flux; and detecting resonance based on frequency of a reflection of the pulse.
9. The method as described in any of clauses 1-8, further comprising: determining a difference between frequency of the resonance and the first nominal resonant frequency; and configuring an amplitude or frequency of the charging current based on the difference.
10. A charging device, comprising: a charging circuit; and a controller configured to: cause an excitation flux to be transmitted from the charging device, the excitation flux being transmitted in a first range of frequencies that includes a first nominal resonant frequency associated with compatible chargeable devices; determine that a compatible chargeable device is available for charging by the charging device when resonance is detected in response to the excitation flux; and provide a charging current to a power transmitting coil of the charging device, the charging current being provided in a second range of frequencies that includes a second nominal resonant frequency associated with the compatible chargeable devices.
11. The charging device as described in clause 10, wherein the first range of frequencies and the second range of frequencies are separated by a third range of frequencies.
12. The charging device as described in clause 10 or clause 11, wherein the first nominal resonant frequency is defined as 1 megahertz and the second nominal resonant frequency is defined as 100 kilohertz.
13. The charging device as described in any of clauses 10-12, wherein the controller is further configured to: provide an excitation signal to an excitation coil that encloses one or more power transmitting coils provided within an area of a surface of the charging device.
14. The charging device as described in clause 13, wherein the controller is further configured to: detect resonance based on phase or gain of a signal received by the power transmitting coil that is a reflection of the excitation signal.
15. The charging device as described in any of clauses 10-14, wherein the controller is further configured to: provide an excitation signal to the power transmitting coil.
16. The charging device as described in clause 15, wherein the controller is further configured to: detect resonance based on phase or gain in a circuit that includes the power transmitting coil.
17. The charging device as described in any of clauses 10-16, wherein the controller is further configured to: provide a pulse to a coil that transmits the excitation flux; and detect resonance based on frequency of a reflection of the pulse.
18. The charging device as described in any of clauses 10-17, wherein the controller is further configured to: determine a difference between frequency of the resonance and the first nominal resonant frequency; and configure an amplitude or frequency of the charging current based on the difference.
19. A processor-readable storage medium having instructions stored thereon which, when executed by at least one processor in a charging device, cause the processor to: cause an excitation flux to be transmitted from the charging device, the excitation flux being transmitted in a first range of frequencies that includes a first nominal resonant frequency associated with compatible chargeable devices; determine that a compatible chargeable device is available for charging by the charging device when resonance is detected in response to the excitation flux; and provide a charging current to a power transmitting coil of the charging device, the charging current being provided in a second range of frequencies that includes a second nominal resonant frequency associated with the compatible chargeable devices.
20. The processor-readable storage medium as described in clause 19, wherein the instructions cause the processor to: determine a difference between frequency of the resonance and the first nominal resonant frequency; and configure an amplitude or frequency of the charging current based on the difference.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A method for operating a charging device, comprising:
transmitting an excitation flux from the charging device, the excitation flux being transmitted in a first range of frequencies that includes a first nominal resonant frequency associated with compatible chargeable devices;
determining that a compatible chargeable device is available for charging by the charging device when resonance is detected in response to the excitation flux; and
providing a charging current to a power transmitting coil of the charging device, the charging current being provided in a second range of frequencies that includes a second nominal resonant frequency associated with the compatible chargeable devices.

2. The method of claim 1, wherein the first range of frequencies and the second range of frequencies are separated by a third range of frequencies.

3. The method of claim 1, wherein the first nominal resonant frequency is defined as 1 megahertz and the second nominal resonant frequency is defined as 100 kilohertz.

4. The method of claim 1, wherein transmitting the excitation flux comprises:
providing an excitation signal to an excitation coil that encloses one or more power transmitting coils provided within an area of a surface of the charging device.

5. The method of claim 4, further comprising:
detecting resonance based on phase or gain of a signal received by the power transmitting coil that is a reflection of the excitation signal.

6. The method of claim 1, wherein transmitting the excitation flux comprises:
providing an excitation signal to the power transmitting coil.

7. The method of claim 6, further comprising:
detecting resonance based on phase or gain in a circuit that includes the power transmitting coil.

8. The method of claim 1, further comprising:
providing a pulse to a coil that transmits the excitation flux; and
detecting resonance based on frequency of a reflection of the pulse.

9. The method of claim 1, further comprising:
determining a difference between frequency of the resonance and the first nominal resonant frequency; and
configuring an amplitude or frequency of the charging current based on the difference.

10. A charging device, comprising:
a charging circuit; and
a controller configured to:
cause an excitation flux to be transmitted from the charging device, the excitation flux being transmitted in a first range of frequencies that includes a first nominal resonant frequency associated with compatible chargeable devices;
determine that a compatible chargeable device is available for charging by the charging device when resonance is detected in response to the excitation flux; and
provide a charging current to a power transmitting coil of the charging device, the charging current being provided in a second range of frequencies that includes a second nominal resonant frequency associated with the compatible chargeable devices.

11. The charging device of claim 10, wherein the first range of frequencies and the second range of frequencies are separated by a third range of frequencies.

12. The charging device of claim 10, wherein the first nominal resonant frequency is defined as 1 megahertz and the second nominal resonant frequency is defined as 100 kilohertz.

13. The charging device of claim 10, wherein the controller is further configured to:
provide an excitation signal to an excitation coil that encloses one or more power transmitting coils provided within an area of a surface of the charging device.

14. The charging device of claim 13, wherein the controller is further configured to:
detect resonance based on phase or gain of a signal received by the power transmitting coil that is a reflection of the excitation signal.

15. The charging device of claim 10, wherein the controller is further configured to:
provide an excitation signal to the power transmitting coil.

16. The charging device of claim 15, wherein the controller is further configured to:
detect resonance based on phase or gain in a circuit that includes the power transmitting coil.

17. The charging device of claim 10, wherein the controller is further configured to:
provide a pulse to a coil that transmits the excitation flux; and
detect resonance based on frequency of a reflection of the pulse.

18. The charging device of claim 10, wherein the controller is further configured to:
determine a difference between frequency of the resonance and the first nominal resonant frequency; and
configure an amplitude or frequency of the charging current based on the difference.

19. A processor-readable storage medium having instructions stored thereon which, when executed by at least one processor in a charging device, cause the processor to:
cause an excitation flux to be transmitted from the charging device, the excitation flux being transmitted in a first range of frequencies that includes a first nominal resonant frequency associated with compatible chargeable devices;
determine that a compatible chargeable device is available for charging by the charging device when resonance is detected in response to the excitation flux; and
provide a charging current to a power transmitting coil of the charging device, the charging current being provided in a second range of frequencies that includes a second nominal resonant frequency associated with the compatible chargeable devices.

20. The processor-readable storage medium of claim 19, wherein the instructions cause the processor to:
determine a difference between frequency of the resonance and the first nominal resonant frequency; and
configure an amplitude or frequency of the charging current based on the difference.
